(19) United States
(12) Patent Application Publication
(10) Pub. No.: US 2018/0274968 A1
(43) Pub. Date: Sep. 27, 2018

(54) SYSTEM AND METHOD FOR DETERMINING WHEEL LOAD

(71) Applicant: AGCO International GmbH, Neuhausen (CH)

(72) Inventor: Martin Brenninger, Marktoberdorf (DE)

(21) Appl. No.: 15/928,181

(22) Filed: Mar. 22, 2018

(30) Foreign Application Priority Data
Mar. 22, 2017 (GB) 1704512.1

(51) Int. Cl. G01G 19/10; G07C 5/08; B62D 49/00

(52) U.S. Cl. CPC G01G 19/10; B62D 49/00; G07C 5/085

(57) ABSTRACT

A system and method for determining the wheel load for a wheel of a first axle, based on the wheel load for a wheel of a second axle, and the wheel speed ratio between the first and second axle. As a result, wheel load can be calculated for axles not easily adapted to receive load sensors, e.g. a rear axle of an agricultural tractor. The system uses a characteristic map of the relationship between wheel load and wheel geometry, e.g. wheel circumference, for different tire pressure values of a wheel to provide an efficient and effective mechanism for the determination of wheel load.

### BACKGROUND OF THE INVENTION

### Field of the Invention

The present invention relates to a system and method for determining wheel load, preferably for a rear axle wheel of an agricultural tractor.

### Description of Related Art

In many vehicles, it can be advantageous to provide a system to determine the precise wheel load for each wheel or axle of the vehicle. For example, in vehicles equipped with tire pressure regulation systems, the wheel load is used to enable the adjustment of tire pressures without exceeding the tire capability, or the generation of an optimised load distribution profile to provide guidance to the operator on ballasting of the tractor.

It is well known, for suspended axles, to determine the wheel load by measuring the pressure in the hydraulic or pneumatic cylinders of the suspension. However, in the case of an agricultural tractor, only the front axle is equipped with such a suspension system from which the wheel load may be determined, so the rear axle requires a different solution. According to one approach, it is known to use axle bearings which are equipped with load sensing means. These means require changes in the axle installation and are costly. Furthermore, optional usage is not generally an economic option due to the impact of the changes on the complete axle design and the resulting costs.

An alternative solution is shown in European Patent No. EP 2802202 B1, wherein strain sensors are attached to certain locations of a rear axle trumpet housing, in an effort to provide an accurate determination of wheel load. However, such solutions continue to require additional effort in design and manufacture to accommodate such sensors and the communication apparatus associated therewith.

As a result, it is an object of the invention to provide a vehicle having an improved system for determining wheel load.

### SUMMARY OF THE INVENTION

Accordingly, there is provided a method for determining the wheel load for a wheel of an axle, the method comprising:
determining the wheel load for a wheel of a first axle (“first axle wheel”) based on a tire pressure of the first axle wheel and a wheel geometry of the first axle wheel,
wherein the wheel geometry of the first axle wheel is determined based on the wheel geometry of a wheel of a second axle, and the wheel speed ratio between the first and second axles.

As some vehicles may not easily provide for accurate measurement of wheel load for all vehicle axles, the present invention provides a system for determining the wheel load for a first axle based on information derived from a second axle, and the ratio of the rotational speed between the wheels of the first and second axles. This allows for the simple and accurate determination of the wheel load of the first axle, without the need for a direct measurement of the wheel load or other strain-related elements at the first axle. It will be understood that the invention is intended for use in the case of axles which independently rotate, i.e. the front and rear axles are not drivingly connected to each other.

The wheel geometry may comprise any suitable characteristic of the wheel, preferably the wheel circumference, but may additionally or alternatively comprise the radius of the wheel, the diameter, etc.

In a particularly preferred embodiment, the method is configured for determining the wheel load for a wheel of a rear axle of an agricultural tractor. Preferably, the first axle is a rear axle of an agricultural tractor. Preferably, the second axle is a front axle of an agricultural tractor.

Due to the constructional design of agricultural tractors, the front axle is generally provided with a suspension system to allow for movement of the wheels of the front axle relative to the rest of the tractor body. As such, the wheel load of a wheel of a front axle of an agricultural tractor can be relatively easily measured, through the use of appropriate load sensors, and/or by monitoring the hydraulic pressure in the suspension system. By contrast, the rear axle of an agricultural tractor is generally provided without a suspension system, and rigid with the tractor body, such that measurement of the wheel loads of the rear axle of an agricultural tractor can present significant challenges for an operator. Accordingly, the use of known data from the front axle of the tractor, as well as the monitored tire pressure of the rear axle, can provide a simple method of the calculation of the wheel load of a rear axle of a tractor.

Preferably, the method comprises the step of providing a characteristic profile for the first axle wheel, the characteristic profile defining the relationship between a wheel load and a wheel geometry for different tire pressure values, and wherein the step of determining the wheel load for the first axle wheel comprises calculating the wheel load based on the tire pressure and the wheel geometry of the first axle wheel using the characteristic profile for the first axle wheel.

For a particular vehicle wheel, the wheel geometry and the wheel load are related, based on the tire pressure of the wheel. By retaining this information in the form of a characteristic profile, accordingly the wheel load can be determined for a wheel when the tire pressure and the wheel geometry of the wheel are known.

Preferably, the method comprises the step of determining the wheel geometry of the second axle wheel, based on the wheel load of the second axle wheel and the tire pressure of the second axle wheel.

Preferably, the method comprises the step of receiving a wheel load for the second axle wheel, further preferably by monitoring the output of a load sensor of the second axle wheel. Additionally or alternatively, the wheel load of the second axle wheel may be determined by monitoring cylinder pressure of an axle suspension cylinder for the second axle wheel.

Preferably, the method comprises the step of receiving a tire pressure for the second axle wheel, preferably by monitoring the tire pressure of the second axle wheel.

Preferably, the step of monitoring comprises receiving the output of a tire pressure sensor for the second axle wheel. The tire pressure sensor may be provided as part of a tire pressure control system of the wheel.

Preferably, the method comprises the step of providing a characteristic profile for the second axle wheel, the characteristic profile defining the relationship between a wheel load and a wheel geometry for different tire pressure values, and wherein the step of determining the wheel geometry for the second axle wheel comprises calculating the wheel geometry based on the tire pressure and the wheel load of the second axle wheel using the characteristic profile for the second axle wheel.

The characteristic profiles of the first axle wheel and/or the second axle wheel may be stored in an on-board memory of a vehicle, e.g. as a look-up table or similar. Alternatively, the method may comprise the processing of predefined algorithms to determine the characteristic profiles of the first axle wheel and/or the second axle wheel.

Preferably, the method comprises the step of determining the wheel speed ratio between the first and second axles by measuring the rotational speed of the first axle and the rotational speed of the second axle, and calculating the ratio between the measured speeds.

Preferably, step of measuring comprises receiving the output of a speed sensor for the first axle and the output of a speed sensor for the second axle.

It will be understood that measuring the speed of an axle can comprise measuring the rotational speed of at least one wheel of the axle.

Preferably, the method comprises the step of monitoring the tire pressure of the first axle wheel.

Preferably, the step of monitoring comprises receiving the output of a tire pressure sensor for the first axle wheel. The tire pressure sensor may be provided as part of a tire pressure control system for the wheel.

There is also provided a vehicle, preferably an agricultural tractor, having an electronic control unit (ECU) arranged to carry out the method as described above.

The vehicle is provided with a first axle having at least one wheel, preferably a rear axle of an agricultural tractor. The vehicle is provided with a second axle having at least one wheel, preferably a front axle of an agricultural tractor. It will be understood that the front axle and the rear axle are independently rotatable.

Preferably, the vehicle comprises an on-board memory communicatively coupled with the ECU, e.g. as a look-up table, to store the characteristic profile of the first and/or second axle wheels.

Alternatively, the controller is provided with algorithms to determine the characteristic profiles of the first axle wheel and/or the second axle wheel.

Preferably, the vehicle comprises a load sensor provided at the second axle, to determine the wheel load of the second axle wheel.

Additionally or alternatively, the vehicle comprises a pressure sensor arranged to monitor the cylinder pressure of an axle suspension cylinder for the second axle wheel, wherein the wheel load of the second axle wheel is determined based on the monitored cylinder pressure.

Preferably, the vehicle comprises a tire pressure sensor for the first axle wheel and/or for the second axle wheel. The tire pressure sensor may be provided as part of a tire pressure control system of the first or second axle wheels.

There is further provided a system for determining the wheel load for a wheel of an axle, the system comprising an ECU arranged to carry out the steps of the method as described above. It will be understood that the system may be provided as a kit of parts to be installed onto or retrofitted to a vehicle to determine the wheel load for a wheel of an axle of the vehicle. The system may comprise suitable tire pressure sensors, speed sensors, rotational sensors, and/or memory units as appropriate, but it will be understood that the system may be arranged to interface with the pre-existing sensors and systems of the vehicle.

### BRIEF DESCRIPTION OF THE DRAWINGS

Embodiments of the invention will now be described, by way of example only, with reference to the accompanying drawings, in which:

FIG. 1 is a side view of an agricultural tractor having a system for determining wheel load according to the invention;

FIG. 2 is a schematic overview of the system according to the invention;

FIG. 3 is an illustration of a characteristic profile for a wheel of the tractor of FIG. 1, defining the relationship between a wheel load and a wheel circumference for different tire pressure values of the wheel; and

FIG. 4 is an illustration of a characteristic profile for a further wheel of the tractor of FIG. 1.

The drawings are provided by way of reference only, and will be acknowledged as not to scale.

### DETAILED DESCRIPTION OF THE INVENTION

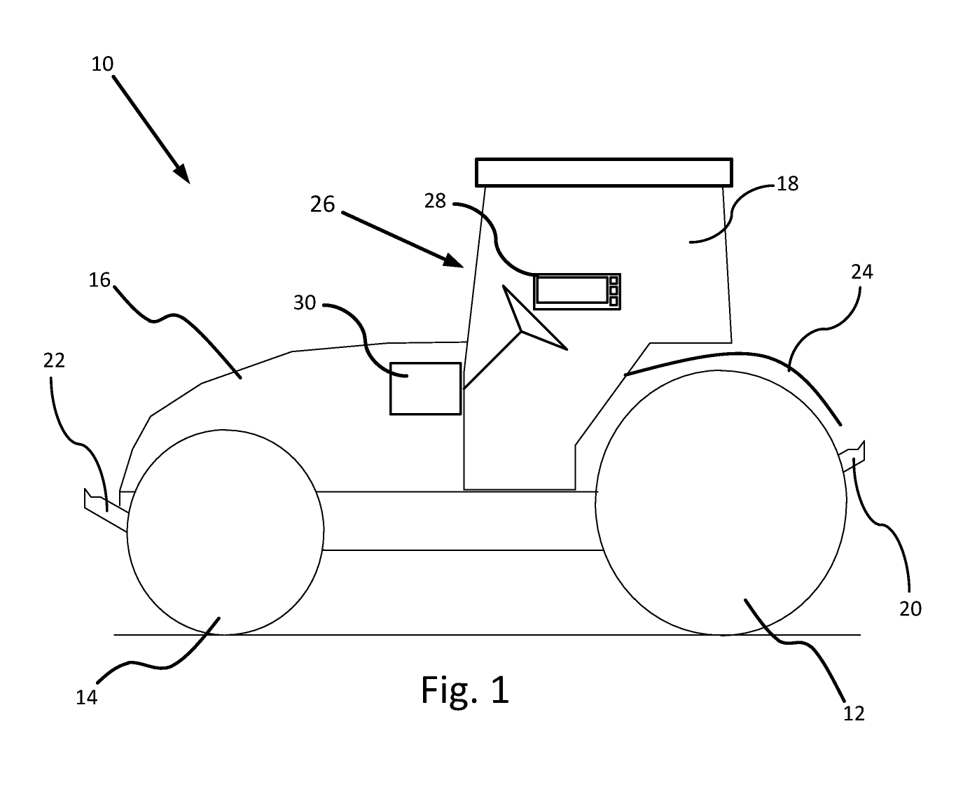

With reference to FIG. 1, a vehicle according to the invention in the form of an agricultural tractor is indicated at 10. The tractor 10 comprises rear wheels 12 and front wheels 14, a forward engine compartment 16 and a cab section 18. A rear linkage 20 is provided at the rear of the tractor 10, and a front linkage 22 is provided at the front of the tractor 10. Rear fenders 24 are provided to cover a portion of the rear wheels 12.

Within the cab 18, an operator station 26 is provided, where the operator can access a display terminal and associated operator controls 28. The tractor 10 is provided with at least one electronic control unit (ECU) 30. The ECU is configured to interface with the operator controls 28 and with the various systems and sensors provided about the tractor 10, to provide for monitoring and control of tractor operation. The operator controls 28 and ECU 30 allow the operator to actuate different elements of the tractor 10, e.g. hydraulic circuits, lifting systems, HVAC operation, and/or to control the acceleration and steering of the tractor 10.

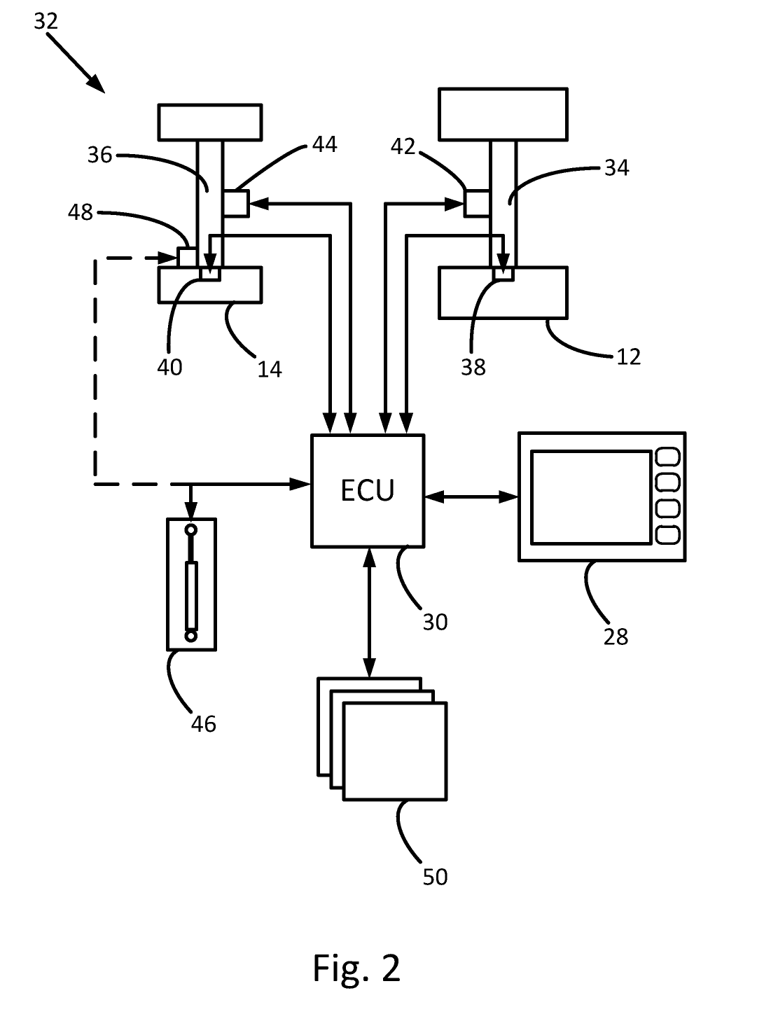

The tractor 10 further comprises a system for determining wheel load for a wheel of an axle of the tractor 10. With reference to FIG. 2, an overview of the system for determining wheel load is indicated generally at 32. The system of FIG. 2 is coupled with a rear axle 34 and a front axle 36 of the tractor of the tractor 10, to which axles rear wheels 12 and front wheels 14 are respectively mounted. While the system 32 is shown in use for one of the rear wheels 12 and one of the front wheels 14, it will be understood that the system and associated components may be replicated for each of the wheels of the tractor 10. The rear and front axles 34,36 are independently rotatable.

The ECU 30 is coupled with a system 38 for monitoring the tire pressure of the rear wheel 12 of the tractor 10. The rear tire pressure system 38 may be provided as a dedicated pressure sensor located in or on the rear wheel 12, or the rear tire pressure system 38 may be provided as part of a tire pressure control system, used for the regulation of tire pressure of the rear wheel 12 during tractor operation.

Similarly, the ECU 30 is coupled with a system 40 for monitoring the tire pressure of the front wheel 14 of the tractor 10. The front tire pressure system 40 may be provided as a dedicated pressure sensor located in or on the front wheel 14, or the front tire pressure system 40 may be provided as part of a tire pressure control system, used for the regulation of tire pressure of the front wheel 14 during tractor operation.

The ECU 30 is coupled with a rear axle speed sensor 42 and a front axle speed sensor 44, which are arranged to monitor the speed of the respective rear and front axles 34,36. Additionally or alternatively, the ECU 30 may be coupled with speed sensors which are arranged to monitor the rotational speed of the individual wheels of the tractor 10.

The ECU 30 is further coupled with a system arranged to monitor the wheel load of the front axle 36, by monitoring the pressure in a suspension system of the front axle 36. The ECU 30 may be connected to a hydraulic cylinder 46 or other axle suspension cylinder of the suspension system to directly monitor the pressure of the suspension system, which can be used to determine the loading of the axle. Additionally or alternatively, the ECU 30 can be connected to a load sensor 48 provided directly at the front axle 36 to monitor the wheel load of the front wheel 14.

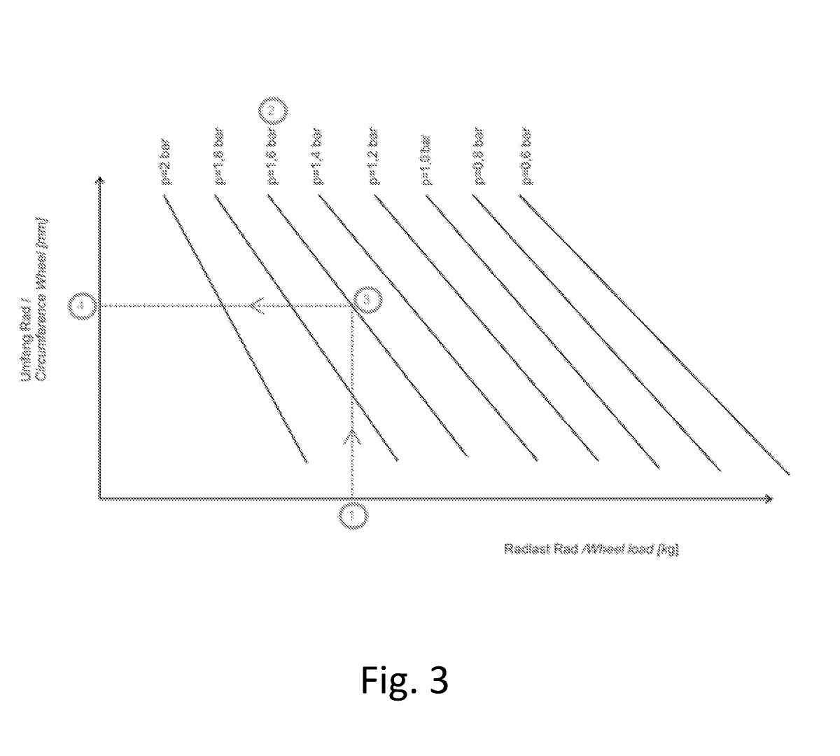

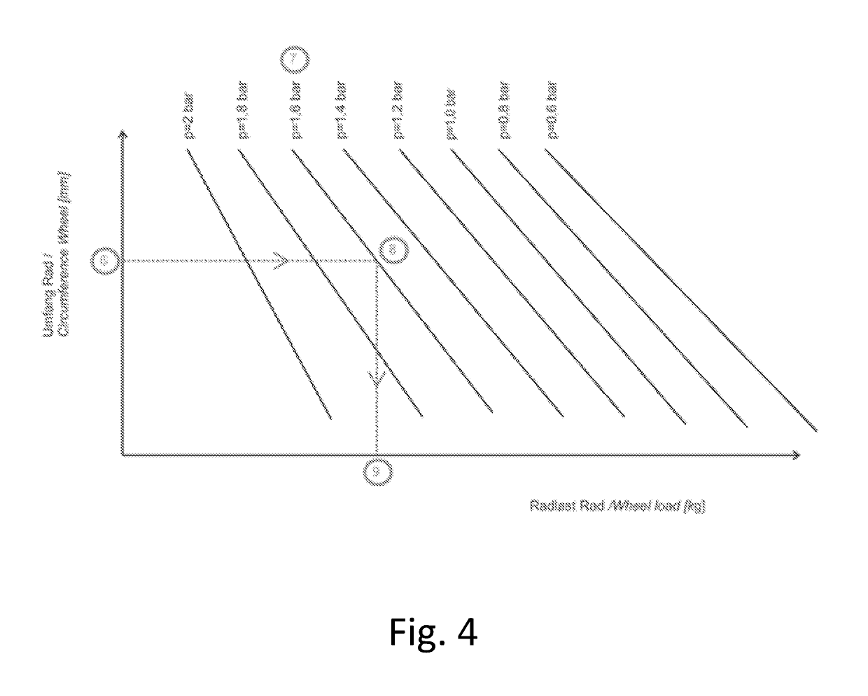

The ECU 30 is further coupled with an on-board memory system 50. The memory system 50 is configured to retain data relating to a characteristic profile of the wheels 12,14 of the tractor 10. In particular, the characteristic profile of a tractor wheel defines the relationship between a wheel load and a wheel circumference for different tire pressure values. The memory system 50 may be arranged to store a plurality of different characteristic profiles for an array of different wheel types, wherein the ECU 30 is adapted to select the correct characteristic profile based on a detection of the wheels 12,14 installed on the tractor 10, or the correct characteristic profiles can be selected by an operator input using the operator controls 28. Examples of the data which may be retained in a characteristic profile are shown in FIGS. 3 and 4.

The characteristic profiles may be stored as a look-up table or similar, to enable the ECU 30 to easily access required data. Alternatively, the ECU 30 may be provided with suitable algorithms from the memory 50 to enable the ECU 30 to dynamically calculate the relationship between wheel load, wheel circumference and tire pressure for a particular wheel.

The wheel load determining system 32 is configured to determine the wheel load for a first axle of a vehicle, using data obtained from a second axle of the vehicle when the both are not drivingly connected to each other. In particular, the system 32 is configured to determine the wheel load using the tire pressure and the wheel circumference for a wheel of the first axle, where the wheel circumference is determined based on the wheel circumference of a wheel of a second axle, and the lead ratio between the first and second axles. As the wheel load for a front axle 36 of the tractor 10 may be relatively easily determined by monitoring the suspension system pressure, accordingly the system 32 is advantageously used to determine the wheel load for the rear axle 34 of the tractor 10, using data from the front axle 36 of the tractor 10.

The method of operation of the system 32 will now be described, with reference to FIGS. 3 and 4. FIG. 3 is an illustration of a characteristic profile for the front wheel 14 of the tractor 10, defining the relationship between a wheel load and a wheel circumference for different tire pressure values of the front wheel 14. Similarly, FIG. 4 is an illustration of a characteristic profile for the rear wheel 12 of the tractor 10, defining the relationship between a wheel load and a wheel circumference for different tire pressure values of the rear wheel 12. As this relationship is provided by a tire manufacturer or determined by the vehicle manufacturer in a calibration process, it is envisaged that the relationship may be described in different ways. For example, instead of the circumference of the wheel depicted on the vertical axis in FIGS. 3 and 4, the wheel radius or diameter may be used, as these three factors can be easily determined depending on each other.

Initially, the wheel load of the front axle 36 is determined, by monitoring the output of the suspension system for the front axle 36. The ECU 30 is arranged to determine the load based on the pressure of a suspension system cylinder 46 of the front axle 36, or by monitoring the output of a dedicated load sensor 48 located at the front wheel 14 of the front axle 36. This determined load is indicated at step 1 of FIG. 3.

The ECU 30 determines the tire pressure of the front wheel 14, based on the output of a pressure sensor 40 provided at the front wheel 14—step 2. Using the characteristic profile for the front axle wheel 14, the intersection of the determined wheel load of the front axle 36 and the measured tire pressure is indicated at step 3, which can then be used to determine the wheel circumference for the front wheel 14—step 4.

When the wheel circumference of the front axle 36 of the tractor 10 is known, it is possible to determine the wheel circumference of the rear axle 35 of the tractor 10, based on the wheel speed of the front and rear axles.

Accordingly, in a fifth step of the method of operation, the ECU 30 is arranged to determine the speed of the rear axle 34 and the front axle 36 based on the monitored outputs of the respective speed sensors 42,44. The monitored speeds and the determined circumference of the front axle wheel from step 4 above are then used to determine the circumference of the wheel 12 of the rear axle 34—step 6 as shown in FIG. 4.

The wheel circumference of the front axle 36 is the distance which the tractor travels during a full 360° rotation of the front axle 36. Accordingly, the combination of the front wheel circumference and the wheel speed provides the travelled distance whereby:
n_{FRONT AXLE} is the front axle speed,
U_{FRONT AXLE} is the circumference of a wheel of the front axle
n_{REAR AXLE} is the rear axle speed,
U_{REAR AXLE} is the circumference of a wheel of the rear axle,
t is the time period considered,

The travelled distance d can be calculated according the equation:

d=n_{Front axle}×U_{Front axle}×t

The same distance with in same time period t must be travelled by the rear axle and its wheel so that an equivalent equation can be applied:

d=n_{Rear axle}×U_{Rear axle}×t

This equation can be used to determine the circumference of a wheel of the rear axle by the equation:

$${U}_{Rear axle} = \frac{d}{{n}_{Rear axle} \times t}$$

Whereby D can be substituted by the equation for the front axle, so that the final equation is received:

$${U}_{Rear axle} = \frac{{n}_{Front axle} \times {U}_{Front axle}}{{n}_{Rear axle}}$$

Alternatively, the numbers of revolutions for front and rear axle within a predetermined time period may be counted to receive a similar relationship.

The ECU 30 then determines the tire pressure of the rear wheel 12, based on the output of the pressure sensor 38 provided at the rear wheel 12—step 7. Using the characteristic profile for the rear axle wheel 12, the intersection of the determined wheel circumference for the rear axle wheel 12 and the monitored tire pressure of the rear axle wheel 12 is indicated at step 8. The characteristic profile can then be used to determine the wheel load for the rear axle wheel 12, indicated at step 9.

The determined wheel load for the rear axle 34 can then be used to control other systems or operations of the tractor 10, for example the regulation of tire pressure throughout the tractor 10 using suitable tire pressure control systems.

The system and method of the invention provides a system for determining the wheel load for a first axle of a vehicle, in particular a rear axle of a tractor, based on information derived from a second axle, in particular a front axle of a tractor. The lead ratio between the first and second axles is used in combination with characteristic profiles of the wheels of the axles which define the relationships between a wheel load and a wheel geometry such as circumference, radius or diameter for different tire pressure values. The system and method of the invention allows for the simple and accurate determination of the wheel load of the first axle, without the need for a direct measurement of the wheel load or other strain-related elements at the first axle.

It will be understood that the invention is particularly intended for use in vehicles where the first axle can be driven independently of the second axle. Such separately drive axles can be provided without any direct mechanical connection between the axles, or with an adjustable mechanical coupling between the axles which allows for torque vectoring (such as described in Applicant's published patent applications WO2014/096450 and WO2014/096450 between the axles of the vehicle. Such vehicles may include agricultural tractors or harvesters.

The invention is not limited to the embodiments described herein, and may be modified or adapted without departing from the scope of the present invention as defined by the following claims.

1. A method for determining the wheel load for a wheel of an axle, the method comprising:
determining the wheel load for a wheel of a first axle based on a tire pressure of the first axle wheel and a wheel geometry of the first axle wheel,
wherein the wheel geometry of the first axle wheel is determined based on the wheel geometry of a wheel of a second axle, and the wheel speed ratio between the first and second axles.

2. The method of claim 1, wherein the wheel geometry comprises at least one of the following: a wheel circumference, a wheel radius, and a wheel diameter.

3. The method of claim 1, wherein the method is configured for determining the wheel load for a wheel of a rear axle of an agricultural tractor, wherein the first axle is a rear axle of an agricultural tractor, and wherein the second axle is a front axle of an agricultural tractor.

4. The method of claim 1, further comprising the step of providing a characteristic profile for the first axle wheel, the characteristic profile defining the relationship between a wheel load and a wheel geometry for different tire pressure values, and wherein the step of determining the wheel load for the first axle wheel comprises calculating the wheel load based on the tire pressure and the wheel geometry of the first axle wheel using the characteristic profile for the first axle wheel.

5. The method of claim 1, wherein the method comprises the step of determining the wheel geometry of the second axle wheel, based on the wheel load of the second axle wheel and the tire pressure of the second axle wheel.

6. The method of claim 5, wherein the method comprises the steps of receiving a wheel load for the second axle wheel, and receiving a tire pressure for the second axle wheel. by monitoring the output of a load sensor of the second axle wheel.

7. The method of claim 5, further comprising the step of receiving a tire pressure for the second axle wheel.

8. The method of claim 7, wherein the step of receiving a tire pressure for the second axle wheel is achieved by monitoring the tire pressure of the second axle wheel.

9. The method of claim 5, wherein the method comprises the step of providing a characteristic profile for the second axle wheel, the characteristic profile defining the relationship between a wheel load and a wheel geometry for different tire pressure values, and wherein the step of determining the wheel geometry for the second axle wheel comprises calculating the wheel geometry based on the tire pressure and the wheel load of the second axle wheel using the characteristic profile for the second axle wheel.

10. The method of claim 1, wherein the method further comprises a step of determining the wheel speed ratio between the first and second axles by measuring the speed of the first axle and the speed of the second axle, and calculating the ratio between the measured speeds, preferably wherein the step of measuring comprises receiving the output of a speed sensor for the first axle and the output of a speed sensor for the second axle.

11. The method of claim 1, wherein the method further comprises a step of monitoring the tire pressure of the first axle wheel.

12. The method of claim 11, wherein the step of monitoring the tire pressure of the first axle wheel is achieved by receiving the output of a tire pressure sensor for the first axle wheel.

13. A vehicle in the form of an agricultural tractor, having an electronic control unit (ECU) arranged to carry out the method as claimed in claim 1.

14. The vehicle of claim 13, wherein the vehicle comprises a first axle having at least one wheel, and a second axle having at least one wheel.

15. The vehicle of claim 14, wherein the first axle is a rear axle of an agricultural tractor and wherein the second axle is a front axle of an agricultural tractor.

16. The vehicle of claim 14, wherein the vehicle comprises an on-board memory communicatively coupled with the ECU, to store a characteristic profile of a wheel of the first and/or second axle, the characteristic profile defining the relationship between a wheel load and a wheel geometry for different tire pressure values of the wheel.

17. The vehicle of claim 14, wherein the controller is provided with algorithms to determine a characteristic profile of the first axle wheel and/or the second axle wheel, the characteristic profile defining the relationship between a wheel load and a wheel geometry for different tire pressure values of the wheel.

18. The vehicle of any claim 14, wherein the vehicle comprises a load sensor provided at the second axle, to determine the wheel load of the second axle wheel.

19. The vehicle of claim 14, wherein the vehicle comprises a tire pressure sensor for the first axle wheel and/or for the second axle wheel.
